(19) United States
(12) Patent Application Publication
(10) Pub. No.: US 2025/0376932 A1
(43) Pub. Date: Dec. 11, 2025

(54) CONTAINMENT RING

(71) Applicant: Evolito LTD, Bicester Oxfordshire (GB)

(72) Inventors: Mukesh PATEL, Bicester (GB); Adam Mark Gantzhorn Wilton, Bicester (GB); John Edward Anthony, Bicester (GB)

(21) Appl. No.: 18/740,283

(22) Filed: Jun. 11, 2024

(30) Foreign Application Priority Data
Apr. 14, 2023 (GB) 2305533.8

(51) Int. Cl. F01D 21/04

(52) U.S. Cl. CPC F01D 21/045; H02K 5/02; H02K 5/04; H02K 5/136

(57) ABSTRACT

A containment ring for a rotor of an axial flux machine, the containment ring comprising: a polymer fibre fabric ring arranged around an outer circumference of a rotor body of the rotor, the polymer fibre fabric ring comprising one or more pockets configured for capturing debris impacting a surface of the polymer fibre fabric ring.

### TECHNICAL FIELD

The present disclosure relates to rotor bodies, rotors, rotor assemblies and axial flux machines.

### BACKGROUND

The move away from internal combustion engines to electric machines, though initially focussed on automotive applications for land-based vehicles, is finding a new focus in the demanding applications of aerospace. Because lifting mass is costly, research effort is turning to maximising efficiencies, torque, speed and reducing mass while at the same time working within a development framework focussed on attaining high power density with reliability and mitigation against failures as these are well understood safety pre-requisites in the aerospace industry.

In keeping with this aerospace development framework, providing mitigation against potential design failures has been a longstanding approach in, for example, aerospace turbo-prop engines where loss of a turbo-fan blade is comparatively rare, but nevertheless containment of a lost blade is built into the engine housing.

For turbo-prop machines the challenge involves containing burst fragments within a localized area in the event of a fan blade fracturing at very high-speed usually due to impact from birds or objects picked up from runways and ingested into the engine.

Considering the turbo-prop example, there are two main types of fan housing containment approaches: “hard wall” systems and “soft wall” systems. The hard wall system includes a ring-shaped containment shell made of high-strength material with sufficient thickness and strength to absorb the kinetic energy of an impacting fan blade. A disadvantage of this approach is that debris can interfere with a still viable rotor causing cascading further damage and eventual loss of all useful function. An additional disadvantage is such strength is presently only achievable using metals which adds ‘insurance’ mass to a machine, i.e., mass that for most and probably all of a machine's life is not required.

An example soft wall system uses a crash or nesting area defined by an inner ring cover and an outer ring cover, the nesting area is made up of a honeycomb usually aluminium or a fibre reinforced composite or other suitable structure/material. Additionally, ballistic materials such as aramid fibres (e.g., Kevlar®) may be wrapped around the shell structure to contain projectile debris that makes its way through the energy absorbing honeycomb structure.

Grooman, U.S. Pat. No. 4,057,359 teaches a flexible cover formed from a ballistic nylon fabric, an aliphatic polyamide fibre, and Kevlar, an aromatic polyamide fibre from DuPont as the basis of forming the cover fabric.

In spite of progress in containment of burst debris, the need for ever lighter structures is called for by electric power train aircraft where weight considerations are driving the development of ever lighter machines with increasing power density.

Electric machines are of two-family formats, radial and axial flux. Each having its own family tree of topologies depending on the application.

For many years radial flux motors/generators dominated aerospace electric machines, despite the advent of a different, axial flux topology. Several reasons can be attributed to the slow rise of axial flux machines, still in their infancy in aerospace, not least difficulty in displacing incumbent, known reliability technologies, but also not helped by challenges in efficient and consistent techniques for production. Axial flux electric machines present considerable challenges in manufacture and yet arguably, provide the best power dense topology for many aerospace drive, lift and generator applications, operating at speeds and torques that suit turbine, prop, and blade, drive sources. Advances continue to be made in axial flux topology, particularly improving power density and manufacturing techniques.

GB2468018 proposes an axial flux machine comprising a series of coils wound around pole pieces spaced circumferentially around the stator and spaced axially (i.e., parallel the rotational axis of the rotor) from the associated rotor. The rotor has two stages comprising discs provided with permanent magnets that face either end of each electromagnetic coil of the stator.

Rotor stages typically comprise a hub region and an annular ring, the annular ring being of soft magnetic material and used to convey magnetic flux between adjacent magnets.

Variations on this format exist, but in general adjacent magnets are surface mounted and spaced circumferentially around the rotor stage annular ring and disposed axially, i.e., parallel the rotation axis of the rotor. High rotational rotor speeds generate high centripetal forces on rotor stages particularly on surface mounted magnets and loss of magnet and associated separator materials and adhesion is a risk for this motor topology.

Loss of magnet adhesion may lead to catastrophic failure of an electric machine, and potentially damage surrounding equipment and structures particularly if the magnet has substantial radial and axial force sufficient to break through the electric machine housing. Even if the housing is capable of containing a lost magnet, continuing rotor rotation with a loose magnet flying around inside the housing can lead to further damage to remaining adhered magnets which in turn may be released causing a failure cascade of escalating damage.

There is accordingly a need for an improved containment means.

### SUMMARY

The present disclosure solves these and other problems by providing a containment ring for a rotor of an axial flux machine that is light weight, resonant free, and provides entrapment of debris in a safe way to reduce the risk of a failure cascade. In general terms, the containment ring of the present disclosure comprises polymer fibre fabric ring that circumferentially lines an inner surface of a rotor housing of an axial flux machine. The material of the ring forms one or more pockets that are configured to entrap flying debris. For example, flying debris may burst through the surfaces of a number of layers of pockets in the ring, losing kinetic energy each time, until it no longer has enough energy to break through the surface of the next pocket, leaving it trapped in the pocket it got to.

Unlike in known aerospace containment arrangements such as those of turbo-props, the pocket arrangement of the present disclosure not only provides an effective way of absorbing energy of incoming debris to prevent direct, high energy impact against the rotor housing, but synergistically it also captures the debris and secures it safely inside the containment ring so that the debris cannot cause a cascade of increasingly severe damage to whatever remains of the still spinning rotor or other parts of the axial flux machine.

Thus according to a first aspect, there is provided a containment ring for a rotor of an axial flux machine, the containment ring comprising: a polymer fibre fabric ring arranged around an outer circumference of a rotor body of the rotor, the polymer fibre fabric ring comprising one or more pockets configured for capturing debris impacting a surface of the polymer fibre fabric ring.

Optionally, the polymer fibre fabric ring comprises one or more perforations configured to tear upon impact of the debris to absorb kinetic energy from the debris.

Advantageously, the regions of fabric closest to the machine rotor and thus receiving the highest energy impact tear along the lines of perforations. The tearing of the fabric along the perforations in addition to its deformation absorbs kinetic energy, for example converting it to heat within the fabric. Tearing along perforations also opens pathways for any debris, e.g. magnetic debris, to be absorbed within the pocket structure of the fibre ring and so keeps this debris away from the still rotating rotor to thereby prevent a cascading damage event from occurring to the rotor. It is also envisaged that in addition to or instead of perforations, the fabric may be made of a plurality of different weight fibres to provide gradation of penetration resistance.

Optionally, the one or more pockets are provided around said outer circumference in a plurality of layers.

Advantageously, providing the pockets in layers increases the efficacy of debris capture as each layer that is penetrated reduces the kinetic energy of the debris until a pocket layer is able to resist the impact and thereby capture the debris within a pocket of that layer.

Optionally, at least one of the perforations extends from a first layer into a second layer of said pockets and wherein the tearing of the perforation provides a path for the debris to move through the first layer into the second layer.

Advantageously, by providing the perforations across pocket layers, the high kinetic energy impact on the first layer will tear the perforation down into the second layer and so on, thereby opening up a path for the debris deep into the ring, guiding it away from the still rotating rotor and facilitating the capture of the debris deep inside the ring. This deep capture further reduces the risk of a damage cascade event catastrophically damaging the rotor.

Optionally, the tear path extends under a non-torn portion of the first layer whereby the debris is captured under the non-torn portion of the first layer.

Advantageously, the tear path e.g. as determined by the direction of the perforations within the layers of the ring may be angled at non-perpendicular angle relative to the surface of the ring being penetrated by the debris, effectively providing an angled path for the debris into the ring, allowing the debris to be guided away from the entry hole and onwards at an angle away from the entry hole. This reduces the risk that the debris may be able to escape the ring via the entry hole as might be the case if the perforations were to be perpendicular with the surface of the ring where the debris enters.

Optionally, at least one of the pockets is configured to absorb kinetic energy from the debris by deforming, and at least one of the pockets is configured to retain the debris.

Advantageously, and as described above, the pockets are configured to deform i.e. change shape, and this deformation absorbs kinetic energy of the debris. Optionally, where multiple layers of pockets or voids between corrugations (as will be described below) are provided, the deformation absorbs the kinetic energy of the debris each time the debris passes into and/or through the pockets or voids until eventually the kinetic energy is reduced enough for the debris to be unable to burst through into the next pocket or void and thus facilitating the capture of the debris in the last penetrated pocket or void.

Optionally, said deforming comprising a collapsing of the pocket.

Advantageously, the inventors have found that a collapse of the pocket, that is a break or tear in a pocket and a pulling or pushing force inwards towards the centre of the pocket, most effectively absorbs kinetic energy compared to other forms of deformation.

Optionally, at least one of the pockets is provided with an aperture configured to receive debris therethrough to capture the debris inside the pocket.

Advantageously, apertures into the pockets, for example small holes, slots, or other openings allow small and low kinetic energy debris to be captured. Specifically, one problem with cascading damage events is that they often start with small or tiny items of debris that are not necessarily energetic or massive enough to penetrate through the ring and into a pocket of the ring. These small or tiny items of debris accordingly remain flying around by the spinning rotor, causing impacts with surfaces and thereby generating more debris until eventually large enough and energetic enough items of debris are generated to penetrate into the pockets. However, by this time, the damage may already have been caused and a damage cascade event may be underway. Stopping the start of the cascade before it has had the chance to become unstoppable is accordingly desirable and may be achieved by providing apertures to capture the tiny and small debris items very early on in any damage cascade. It is envisaged that the apertures may be provided only on one or more of the outer layer of pockets, or alternatively, throughout multiple layers of pockets for example in a manner where they are not aligned with each other, thereby allowing small and tiny debris items to work their way through the apertures, and deep into the ring where they are unlikely to be able to escape again.

Optionally, an inside surface of at least one of the pockets is provided with an adhesive for securing debris thereto.

Advantageously, the adhesive ensures that any debris that does enter a pocket is securely captured and retained inside the pocket, thus further enhancing the ability of the ring to prevent a damage cascade event from starting. Further, the adhesive reduces the risk that any loose, torn material of the containment ring after impact is able to snag on the still spinning rotor.

Optionally, the polymer fibre fabric ring comprises a microsphere material, the microsphere material comprising an adhesive configured to be released upon impact of the debris onto the microsphere material.

Advantageously, the microsphere material allows adhesive to be stored in a manner that has a long shelf-life and in a way that it remains effective to secure and retain any debris that causes the microspheres of the material to burst. For example, the debris may burst through a number of layers of pocket material, thereby breaking the microspheres and causing adhesive to be released where the material has been broken, covering the area in adhesive and causing the debris to be retained.

Optionally, the ring may comprise an absorbent material configured to absorb leaking fluid of the axial flux machine.

Advantageously, this allows the ring to not only capture debris, but also fluids such as oil, coolant, water, and so on which may from time to time leak from the components of the axial flux machine, rotor, or vehicle (e.g. a flying vehicle) in which the rotor is installed. Such leaks, while not necessarily causing a damage cascade, can over time cause damage to the rotor and its components and accordingly providing the ring with a dual purpose of debris and fluid capture allows this risk to be minimised without any additional weight or mass additions to the rotor, thereby providing a lightweighting advantage in aerospace settings.

Optionally, a rotor-facing surface of the polymer fibre fabric ring defines one or more corrugations thereon.

Advantageously, the corrugations may facilitate guided deflection of debris to reduce velocity and guide debris to other regions of the containment ring which will collect, tear, and capture and retain debris. The corrugations may also deform to provide shock absorption.

Optionally, the corrugations may define threading on the rotor-facing surface.

Advantageously, the threading shape is configured to harness the tangential velocity of any flying debris by guiding it with the non-zero thread or helix angle of the threading towards one or more capture regions away from the air gap in which the rotor is rotating.

According to a further aspect, there is provided, a rotor of an axial flux machine, the containment ring comprising: a polymer fibre fabric ring arranged around an outer circumference of a rotor body of the rotor, the polymer fibre fabric ring defining one or more corrugations configured for capturing debris impacting a surface of the polymer fibre fabric ring.

Advantageously, providing corrugations, for example in layers, achieves a similar effect as that of the pockets, that is the gaps between the layers of corrugations act as a space or void into which flying debris may be captured.

Thus, optionally, the polymer fibre fabric ring comprises a plurality of layers of corrugations together forming a plurality of enclosed spaces for capturing said debris.

According to a further aspect, there is provided, a rotor for an axial flux machine, the rotor comprising: a disc-shaped rotor body having an axis of rotation and an opening at the axis of rotation; a plurality of permanent magnets mounted to a first face of the rotor body circumferentially around the axis of rotation; and a containment ring as described above arranged around an outer circumference of the rotor body.

Advantageously, a rotor provided with the containment ring described above is provided with a reduced risk of damage cascade events occurring.

Optionally, the rotor comprises a rotor housing for housing the disc-shaped rotor body, wherein the one or more pockets of the containment ring are arranged around an inner circumference of the rotor housing to protect said inner circumference from said debris.

Advantageously, arranging the containment ring around an inner circumference of the rotor housing allows the housing to be protected from flying debris ensuring the debris remains contained inside the housing (within the pockets of the ring) and thus does not fly out of the rotor housing and risk damaging other components of a vehicle the rotor is installed in or on.

Optionally, the rotor housing comprises a material vulnerable to debris penetration.

Advantageously, as the containment ring provides protection, there is no need to make the housing out of steel or other heavy, high mass, and thus highly protective, materials that would otherwise have been needed to protect the rest of the vehicle the rotor is installed in or on from damage. Thus, lighter weight, more vulnerable materials may be used which provides a substantial lightweighting advantage particularly suited to aerospace applications.

Optionally, said material comprises aluminium, magnesium, and/or alloys thereof and/or a polymer, for example one or more engineering plastics, for example polylyetheretherketone (PEEK) or high density poly ethylene (HDPE).

Optionally, the rotor housing comprises a pressure release configured to depressurise a space inside the rotor housing.

Advantageously, a pressure release such as an overpressure spring sealed valve, a rupture disc allowing for sudden increase in overpressure or similar pressure release device which may be of single operation or one that may reset, ensures that any build up of pressure caused by flying debris and/or capture of that debris in the containment ring does not cause a catastrophic pressure blow out of the rotor housing. Specifically, sliding friction caused by debris may generate substantial amounts of heat which thus has a risk of substantially increasing pressure inside the rotor housing. The damage cascade event thus not only has the potential to cause damage from the debris, but the pressure build up can result in the rotor housing becoming a pressure explosion risk, which may catastrophically damage any vehicle the rotor is installed in or on. The pressure release accordingly mitigates this risk.

According to a further aspect, there is provided an axial flux machine according to any preceding claim comprising: the rotor described above, and a stator.

Advantageously, an axial flux machine provided with the rotor described above has a reduced risk of damage cascade events occurring.

According to a further aspect, there is provided a flying vehicle, such as an aircraft, drone, helicopter, and others, comprising the axial flux machine described above.

Advantageously, a flying vehicle provided with the axial flux machine described above has improved safety in a lightweight manner due to the reduced risk of damage cascade events occurring.

### BRIEF DESCRIPTION

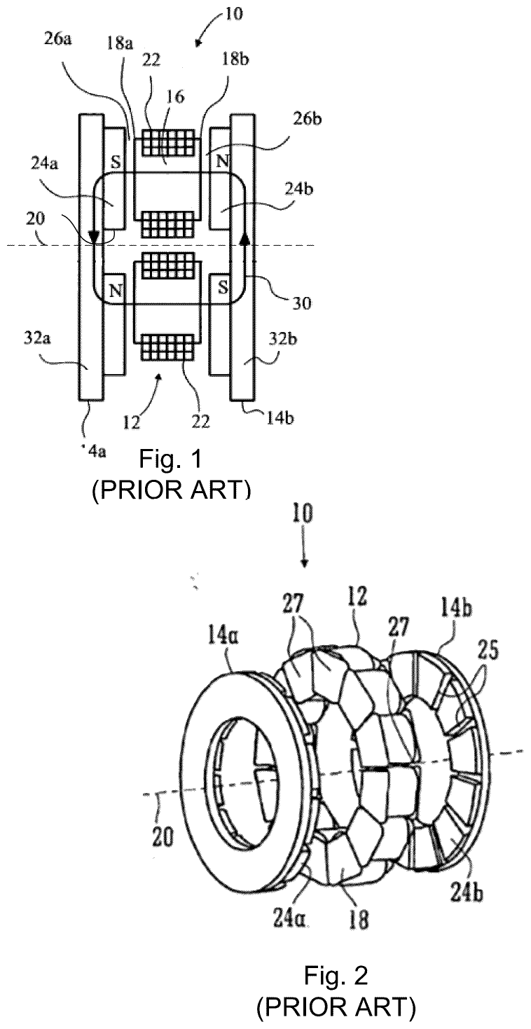

These and other aspects will now be described with reference to the Figures, in which: FIG. 1 illustrates an example known yokeless and segmented armature (YASA) machine.

FIG. 2 illustrates an example known yokeless and segmented armature (YASA) machine.

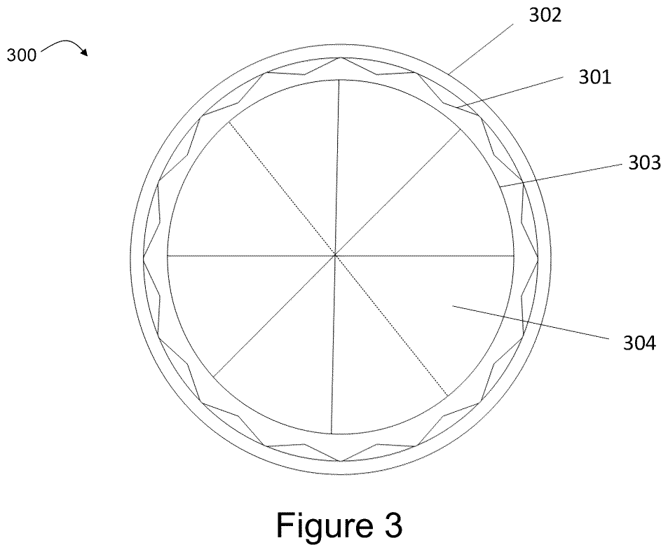

FIG. 3 illustratively shows a containment ring according to the present disclosure.

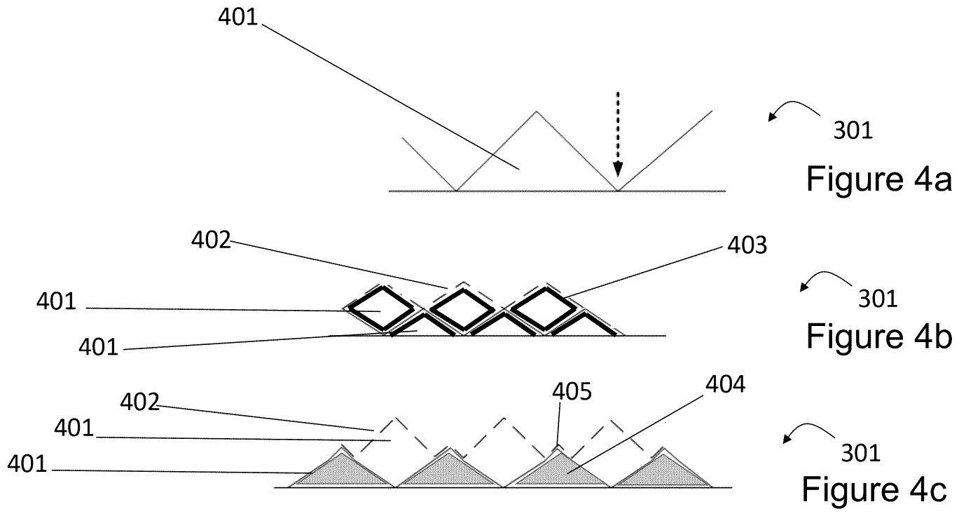

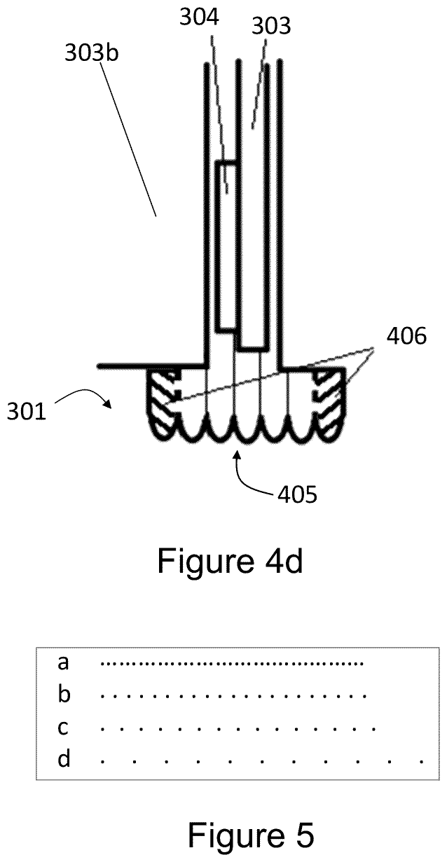

FIG. 4a illustratively shows an example construction of a ballistic fibre ring according to the present disclosure.

FIG. 4b illustratively shows an example construction of a ballistic fibre ring according to the present disclosure.

FIG. 4c illustratively shows an example construction of a ballistic fibre ring according to the present disclosure.

FIG. 4d illustratively shows an example construction of a ballistic fibre ring according to the present disclosure.

FIG. 5 illustratively shows a number of examples of different perforation spacing according to the present disclosure.

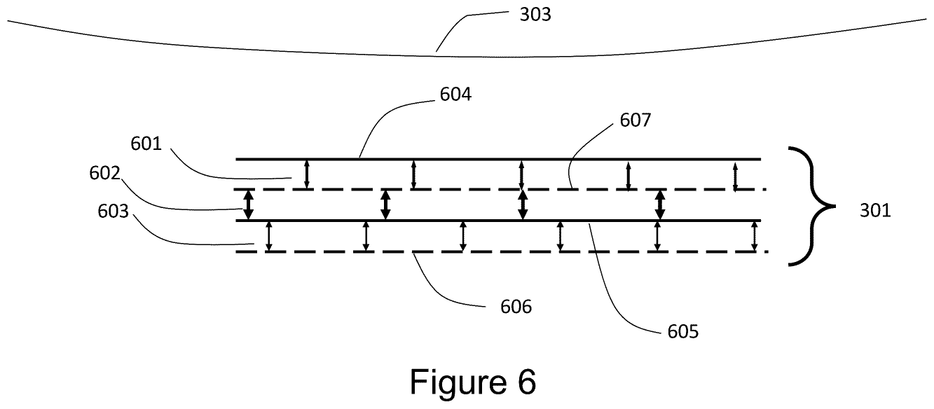

FIG. 6 illustratively shows an example layer structure of the ballistic fabric according to the present disclosure.

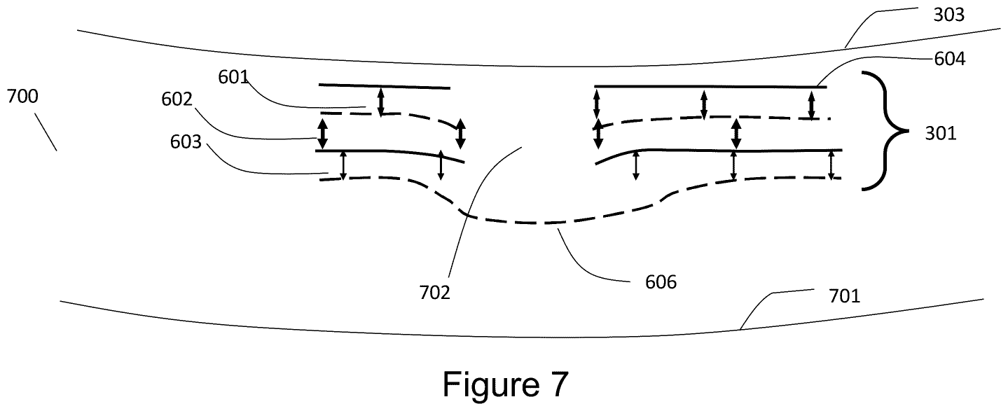

FIG. 7 illustratively shows an example layer structure of the ballistic fabric according to the present disclosure.

### DETAILED DESCRIPTION

FIGS. 1 and 2 are taken from WO2012/022974, and show details of an example known yokeless and segmented armature (YASA) machine 10. The machine 10 may function either as a motor or as a generator.

The machine 10 comprises a stator 12 and, in this example, two rotors 14a,b. The stator 12 comprises a collection of separate stator bars 16 spaced circumferentially about a machine axis 20, which also defines an axis of the rotors 14a,b. Each bar 16 carries a stator coil 22, and has an axis which is typically disposed parallel to the rotation axis 20. Each end 18a,b of the stator bar is provided with a shoe 27, which helps to confine coils of the stator coil 22 and may also spread the magnetic field generated by the stator coil. The stator coil 22 may be formed from square or rectangular section insulated wire so that a high fill factor can be achieved. In a motor the stator coils 22 are connected to an electrical circuit (not shown) that energizes the coils so that poles of the magnetic fields generated by currents flowing in the stator coils are opposite in adjacent stator coils 22.

The two rotors 14a,b carry permanent magnets 24a,b that face one another with the stator coil 22 between. When the stator bars are inclined (not as shown) the magnets are likewise inclined. Gaps 26a,b are present between respective shoe and magnet pairs 17/24a, 27/24b. In an example motor the stator coils 22 are energized so that their polarity alternates to cause coils at different times to align with different magnet pairs, resulting in torque being applied between the rotor and the stator. In FIGS. 1 and 2 the structural strength of the stator housing is achieved by providing a suitably thick layer of polymer, for example greater than 10 mm and bolting the polymer to an outer housing.

The rotors 14a,b are generally connected together, for example by a shaft (not shown), and rotate together about the machine axis 20 relative to the stator 12. In the illustrated example a magnetic circuit 30 is formed by two adjacent stator bars 16, two magnet pairs 24a,b, and two back plates 32a,b, one for each rotor, linking the flux between the backs of each magnet pair 24a,b facing away from the respective coils 22. The back plates 32a,b of WO2012/022974 in may be referred to as rotor bodies or back irons and, in the known examples of FIGS. 1 and 2 comprise a metal, magnetic material, typically a ferromagnetic material, which has a high mass and is thus not suitable for aerospace use. The stator coils 16 are enclosed within a housing which defines a chamber for the rotors and stator, and which may be supplied with a cooling medium.

FIG. 3 illustratively shows a containment ring 300, for a rotor of an axial flux machine. The ring 300 of the FIG. 3 has a complex structure, with resilience to impact such that the ring firstly deforms and disperses energy from a magnet 304 of a rotor 303 that has lost adhesion under the centripetal force of high-speed rotation, which causes the magnet and associated materials to become high-speed projectiles.

In accordance with measures to reduce weight, whilst maintaining or improving functionality, with reference to FIG. 3, the ring comprises a ballistic fabric (i.e. fibre) ring 301 that is made from one or more materials in the group aramid, polyimide, PEEK, PEKK, PPS, high strength nylons, of which Kevlar® is an example. The ballistic fibre ring 301 may be manufactured as a single part with design tolerance such that it fits within the inner surface of a lightweight rotor housing 302. The rotor housing 302 can be of low weight construction and not designed to prevent debris penetration. For example, the rotor housing 302 may comprise one or more of the following materials aluminium, magnesium, and/or alloys thereof, or plastic, for example one or more engineering plastics, for example, polylyetheretherketone (PEEK) or high density poly ethylene (HDPE).

FIGS. 4a, 4b, 4c, and 4d respectively show three illustrative, example constructions of the ballistic fibre ring 301. It will be appreciated that other constructions may also be to the extent they fall under the teachings of the present disclosure. These illustrative example constructions have pockets 401, which enable the fabric to deform and absorb energy.

With reference to FIGS. 4b and 4c, the ballistic fabric ring 301 may be of several layers 402 each providing pockets which deform and absorb energy from striking projectiles.

Ballistic fibre layers 402 may be perforated such that regions of fabric closest to the machine rotor and receiving of highest energy impact will tear along lines of perforations. Tearing of the fabric in addition to its deformation absorbs kinetic energy converting to heat within the fabric.

Tearing of fabric along perforations opens pathways for magnet debris to be absorbed within the pocket structure of the ballistic fabric ring 301 and so remove debris from impact with a still rotating rotor 303.

Rather than perforations to manage resistance to penetration, ballistic fibre fabric may be made of different weight fibres providing a gradation of penetration resistance.

Rotor magnets 304 and supporting material that in instance of fault may lose adhesion to a rotor 303 and become flying ‘debris’, such debris may be dragged by the rotating rotor 303 and slide with friction against a stator wall of an axial flux machine to which the rotor and stator belong. Debris may take a spiral path relative to a rotating rotor as it moves under centrifugal force towards the containment ring 300 of the present invention. Sliding friction generates heat and there is included in the rotor housing 302 a means (not shown) of releasing pressure via a release valve (not shown) that may build due to temperature rise in the air/gas atmosphere surrounding the rotor as a result of debris friction against the rotor 303, against the stator wall (not shown) and against the containment ring 300. A release valve(s) may take the form of one or more of an overpressure spring sealed valve, a rupture disc allowing for sudden increase in overpressure or similar pressure release device which may be of single operation or one that may reset.

Kinetic energy being a function of mass and velocity², it is possible small pieces of debris may not have sufficient energy to penetrate the ballistic fabric ring 301 and, to accommodate and ingest out of harm's way such small debris of low mass, apertures are formed in the outermost layer of the ballistic fabric ring 301 i.e., that layer closest to the rotor 303 rim. Apertures are of sufficient size to allow passage of pieces of highest density debris that would not tear the ballistic fabric. Such purposeful inbuilt apertures are built within and alongside the ballistic fabric ring 301 structure having tear perforations that accommodate through tearing, higher energy projectile debris.

Debris from the rotor 303 may contain intermetallic permanent magnetic material which is brittle and often breaks into small particles <1 mm and often <200 μm. Such small particles may still behave as permanent magnets, though due to their size/mass they will have low magnetisation and magnetic forces on them and by such particles will be small i.e., typically <1-5 gmf. Such permanent magnet particles may adhere to a soft magnetic material or be locked in place by a pressure sensitive adhesive.

For example, internal surfaces of pockets 401 in the fabric ring 301 may be provided with a pressure sensitive adhesive 403 with a similar effect to that of fly-paper, retaining magnet dust and small fragments and preventing such debris from re-entering the rotor chamber causing further damage. Similarly internal surfaces of pockets in the fabric ring 301 may be lined with thin films of soft or hard magnetic material (not shown) onto which magnet dust and small fragments can adhere through magnetic attraction. There is value in distributing and preventing re-escape of permanent magnet debris to prevent such from re-coalescing into larger potentially damaging objects. Pressure sensitive adhesive 403 may be formulated from the group of e.g., aliphatic, aromatic, hydrogenated hydrocarbon and cycloaliphatic resins. Soft magnetic material may include ferrite bonded films, planar-flow cast iron silicon alloys, and hard magnetic materials may include hexa-ferrite bonded films and similar weakly permanent magnetic electrically insulative sheet-like materials.

Additionally or alternatively, the ballistic fabric ring 301 may be made with pockets 401 containing low density syntactic polymer or glass microsphere foams 404 wherein microspheres may also contain adhesive components which are released when crushed forming an agent to adhere and retain rotor part debris.

With reference to FIG. 4c, layers of pockets 401 made from ballistic fabric can be built using a wide variety of bonding routes to obtain more or less strength and corrugations 405 (i.e. the surface structure of the rotor facing surface of the ring) can be used to provide different crumple energy for absorbing projectile energy.

Thus, the pockets 401 may be formed from corrugations in the ballistic fabric 301. The corrugations 405 may be tuned for energy absorption using their size, shape, and number, versus containment ring thickness, and corresponding increase in machine volume and mass. The specific chosen design parameters may be based on analytical and experimental investigation.

The shape of the corrugations 405 may include folds and surface features, such as pockets said pockets 401 and re-entrant pockets to catch and retain debris. The corrugations 405 can also facilitate guided deflection of debris to reduce velocity and guide debris to regions that will collect, tear, and capture and retain debris. Finally, the corrugations 405 can deform to provide shock absorption.

As will be appreciated, folds and features (e.g. said corrugations 405) in the containment ring of the present invention are preferably oriented to catch debris that will naturally have a tangential velocity as a result of leaving a rotating rotor 303.

Turning to FIG. 4d, a cross section view through a rotor 303, magnet 304 and stator 303b of an axial flux machine is shown, together with a ballistic fabric 301 ring surrounding the rotor with a further illustrative example corrugation 405 layout. Specifically, the corrugations 405 in FIG. 4d are provided in a spiral or threaded layout (i.e. with a non-zero thread or helix angle) so that any debris that flies off the spinning rotor 303 or magnet 304 may be captured in the threaded shape of the corrugations and guided by the spiral or threaded shape towards a capture region 406 at the start or end of the spiral or threaded layout. It is envisaged that the spiral or threaded layout harnesses tangential motion of the flying debris to guide the debris away from the air gap region in which the rotor is rotating and towards the debris capture region 406. Advantageously, providing two capture regions allows the ring to be conveniently used not only on unidirectional axial flux machines (i.e. those where the rotor is configured to spin only in one direction) but also on axial flux machine where the rotor is configured to rotate in both directions.

Turning to FIG. 5, FIG. 5 illustratively shows a number of examples of different perforation spacings ranging from tiny a, small b, medium c, and large d. As described above, perforations allow any tears to be guided across and between layers of pockets and a combination of different perforation spacing, for example as shown in FIG. 5, may be used. Specifically, the distance between perforations can be defined to adjust the level of energy required to tear from one perforation hole to the next. In FIG. 5, perforations a have the lowest strength, and perforations d have the highest strength. It will accordingly be appreciated that adjustment of perforation hole separation in a two-dimensional array can be used to alter the burst characteristic of the fabric to accommodate different energy impacts and so reduce velocity and eventually arrest debris. Further, thickness of the fabric when adjusted with perforation hole separation distance provides a wide range of tuneable burst and containment parameters.

FIG. 6 illustratively shows an illustrative example layer structure of the ballistic fabric 301. Some or all of the layers of the fabric 301 which make up pockets and/or corrugations may be bonded together or held together for example by loop and hook features. In the latter instance, layers may initially start closely packed and close to rotor 303. In the instance of debris striking the hook and loop bonded ballistic fabric layers 401 the hook and loops give way and the ballistic fabric perforates to accommodate debris.

Ballistic fabric layers 401 may alternatively or additionally be held in an open structure with corrugation pockets with local adhesive or hot-weld attachment or with tie-bars/stitching 601, 602, 603 that maintain layers apart in an already open structure.

In each case movement of debris through layers and layer pockets is accompanied by energy release, slowing debris projectile(s) released from high-speed rotors and bringing debris to a safe rest contained away from potentially a still functioning, though reduced output capability, rotor and electric machine.

As described above, loss of rotor integrity may lead to debris containing magnetic material which may naturally reform into a larger mass. Part of the rotor may remain intact, for example when the failure results in only the magnetic material separating from the rotor. In this case a loosely associated magnetic debris mass may be entrained and impelled around the inside face of the rotor housing through the action of the still rotating rotor. In such an instance the ballistic fabric ring can tear to relieve friction stresses, and thereby preventing the rotor from stalling.

It will be appreciated that a ballistic fabric containment ring 300 of the present invention can be tailored in the ring's ability to ingest, slow down and retain high speed rotor fragments liberated through adhesion/cohesion failure of rotor materials.

It will further be appreciated that as ballistic fabric ring thickness increases, so too does the electric machine's outer housing, with concomitant increase in machine volume and mass. It will be understood that an engineering compromise will be sought which seeks to minimise ring thickness dimensions, whilst enabling the ring to achieve the widest possible containment capability based on mass and velocity of rotor fragments.

With reference to FIG. 6, there is shown a plurality of layers of ballistic fabric 604, 605, 606, 607 forming a ballistic containment ring 300, the layers are “stitched” together with graded strength stitching 601, 602, 603. The lowest strength stitching requiring the smallest force to tear and separate ballistic fabric layers being that of stitches 600 closest to the rotor 303. It is also envisaged that the grading may be in the other direction, that is, the highest strength stitching requiring the largest force to tear and separate the ballistic fabric layers being that of stitches furthest from the rotor 303 in order to achieve a different tearing performance.

Ballistic fabric layer 604 is perforated with relatively low strength tear resistance to easily allow penetration with subsequent layers being more resistant to perforation and delamination due to graded strength of stitching.

Turning to FIG. 7, FIG. 7 illustratively shows an example layer structure using for example the layers of FIG. 6. Multiple ballistic fabric 301 containment layers forming a complete circular ring surrounding the rotor 303 are provided. The layers may initially be closely attached with no pockets and sitting in a position close to the rotor 303 rotating surface.

With reference to FIG. 7, radially outward from the containment ring is provided an annulus of free space 700 bounded by outer casing 701, which may form part of the rotor housing or be a separate component, into which the ring may expand if called to do so by being exposed to radially transitioning rotor debris which on penetrating the first ballistic fabric layer 604 finds subsequent layers more difficult to penetrate, and in so penetrating, delaminates stitches 601, 602, 603 and opens pocket 702. Final ballistic fabric layer 606 is not perforated and is of sufficient strength to prevent passage of rotor debris from reaching casing 701.

Axial flux machine annulus stators of the present invention are generally cooled by a liquid coolant contained by stator inner and outer axial walls and radial walls facing the rotor. Stator radial walls sit in the magnetic airgap between stator bars and permanent magnet poles of the rotor. The smaller the air gap the higher the torque and so magnetic airgaps are preferably of short axial length generally of the order of 0.5 mm to 3 mm thickness including the stator axial wall. Stator axial walls are of organic basis and may be a sheet material composite and can be damaged by passage of debris from a rotor as it passes towards the containment ring of the present invention. Such passage of debris when confined by a rapidly rotating rotor and a stationary stator radial wall may cause the stator radial wall(s) to wear through friction.

Said containment ring and pockets of the present invention may advantageously contain a material to absorb and remove coolant that may escape a liquid cooled stator axial wall if compromised due to damage caused by rotor debris.

The terms upper and lower, radial, axial, and the horizontal and vertical directions as used herein are used to describe the relative positioning of said surfaces and directions relative to each other and are not intended to limit the present disclosure to any given orientation in a coordinate system. The terms upper and lower, and horizontal and vertical are used for convenience of illustration relative to the figures provided herein. Thus, the upper surface is on an opposite side of a feature to the lower surface. Similarly, the inner surface is on an opposite of a feature to the outer surface regardless of the orientation of the feature in the coordinate system.

Though the present invention is described with application to axial flux electric machines of the single stator double rotor topology, a schematic representation of which is shown in the Figures, this should not be construed as being limiting of the application which may equally be applied to other axial flux topologies, such as single rotor double stator, as well as topologies having stacks of multiple rotors and multiple stators. Further, whilst the present disclosure is described in the context of an axial flux machine having a rotor with a housing, it may also be advantageously provided on external radial flux machines and other such machine types to provide the same damage cascade protection. For example, in such other machines, magnetic material debris might pass around a rotor backplate before impacting a rotor housing.

It will be appreciated that the present disclosure is primarily directed to aerospace applications and may be used in main propulsion systems, but it is also envisaged that it may be used for actuation, power generation, and other aerospace systems that use a rotor.

No doubt many other effective alternatives will occur to the skilled person. It will be understood that the invention is not limited to the described embodiments and encompasses modifications apparent to those skilled in the art lying within the scope of the claims appended hereto.

1. A containment ring for a rotor of an axial flux machine, the containment ring comprising:
a polymer fibre fabric ring arranged around an outer circumference of a rotor body of the rotor, the polymer fibre fabric ring comprising one or more pockets configured for capturing debris impacting a surface of the polymer fibre fabric ring.

2. The containment ring of claim 1, wherein the polymer fibre fabric ring comprises one or more perforations configured to tear upon impact of the debris to absorb kinetic energy from the debris.

3. The containment ring of claim 1, wherein the one or more pockets are provided around said outer circumference in a plurality of layers.

4. The containment ring of claim 2, wherein the one or more pockets are provided around said outer circumference in a plurality of layers and wherein at least one of the perforations extends from a first layer into a second layer of said pockets and wherein the tearing of the perforation provides a path for the debris to move through the first layer into the second layer.

5. The containment ring of claim 4, wherein the tear path extends under a non-torn portion of the first layer whereby the debris is captured under the non-torn portion of the first layer.

6. The containment ring of claim 1, wherein at least one of the pockets is configured to absorb kinetic energy from the debris by deforming.

7. The containment ring of claim 1, wherein at least one of the pockets is configured to retain the debris.

8. The containment ring of claim 6, wherein said deforming comprising a collapsing of the pocket.

9. The containment ring of claim 1, wherein at least one of the pockets is provided with an aperture configured to receive debris therethrough to capture the debris inside the pocket.

10. The containment ring of claim 1, wherein an inside surface of at least one of the pockets is provided with an adhesive for securing debris thereto.

11. The containment ring of claim 1, wherein the polymer fibre fabric ring comprises a microsphere material, the microsphere material comprising an adhesive configured to be released upon impact of the debris onto the microsphere material.

12. The containment ring of claim 1 comprising an absorbent material configured to absorb leaking fluid of the axial flux machine.

13. The containment ring of claim 1, wherein a rotor-facing surface of the polymer fibre fabric ring defines one or more corrugations thereon.

14. The containment ring of claim 13, wherein the corrugations define threading on the rotor-facing surface.

15. A containment ring for a rotor of an axial flux machine, the containment ring comprising:
a polymer fibre fabric ring arranged around an outer circumference of a rotor body of the rotor, the polymer fibre fabric ring defining one or more corrugations configured for capturing debris impacting a surface of the polymer fibre fabric ring.

16. The containment ring of claim 15, wherein the polymer fibre fabric ring comprises a plurality of layers of corrugations together forming a plurality of enclosed spaces for capturing said debris.

17. A rotor for an axial flux machine, the rotor comprising:
a disc-shaped rotor body having an axis of rotation and an opening at the axis of rotation;
a plurality of permanent magnets mounted to a first face of the rotor body circumferentially around the axis of rotation; and
a containment ring according to claim 1 arranged around an outer circumference of the rotor body.

18. The rotor of claim 17, comprising a rotor housing for housing the disc-shaped rotor body, wherein the one or more pockets of the containment ring are arranged around an inner circumference of the rotor housing to protect said inner circumference from said debris.

19. The rotor of claim 18, wherein the rotor housing comprises a material vulnerable to debris penetration.

20. The rotor of claim 19, wherein said material comprises one or more of aluminium, magnesium, alloys of aluminium, alloys of magnesium, a polymer.

21. The rotor of claim 17, wherein the rotor housing comprises a pressure release configured to depressurise a space inside the rotor housing.

22. An axial flux machine according to any preceding claim comprising:
the rotor of any of claim 17, and
a stator.

23. A flying vehicle comprising the axial flux machine of claim 22.
